(19) United States
(12) Patent Application Publication
(10) Pub. No.: US 2006/0120428 A1
(43) Pub. Date: Jun. 8, 2006

(54) Distributed feedback (DFB) semiconductor laser and fabrication method thereof

(76) Inventors: Dae Kon Oh, Daejeon-city (KR); Jin Hong Lee, Daejeon-city (KR); Jin Soo Kim, Daejeon-city (KR); Sung Ui Hong, Daejeon-city (KR); Ho Sang Kwack, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/272,611

(22) Filed: Nov. 14, 2005

(30) Foreign Application Priority Data
Dec. 8, 2004 (KR) 10-2004-0103066
Jun. 17, 2005 (KR) 10-2005-0052575

(51) Int. Cl. H01S 3/08

(52) U.S. Cl. 372/96

(57) ABSTRACT

The distributed feedback semiconductor laser includes: a lower clad layer formed on a substrate; a ridge including an active layer and an upper clad layer sequentially formed on the lower clad layer; and a grating formed at a sidewall or both sidewalls of the ridge including the active layer in a direction perpendicular to the active layer and a resonance axis so as to enable a single longitudinal mode oscillation. The grating has parallel grooves that are equally spaced at a period equal to an integer multiple of half of an oscillation wavelength λ (nλ/2, n=1, 2, 3 . . . ).

### CROSS-REFERENCE TO RELATED PATENT APPLICATION

This application claims the benefit of Korean Patent Application Nos. 10-2004-0103066 filed Dec. 8, 2004 and 10-2005-0052575 filed Jun. 17, 2005 in the Korean Intellectual Property Office, the disclosure of which applications is incorporated herein in its entirety by reference.

### BACKGROUND OF THE INVENTION

1. Field of the Invention

The present invention relates generally to a semiconductor laser and a method of fabricating the same and, more particularly, to a distributed feedback (DFB) semiconductor laser and a method of fabricating the same.

2. Description of the Related Art

In general, the distributed feedback (DFB) semiconductor lasers are used in the optical communication systems and the optical measurers. To fabricate a conventional DFB semiconductor laser, a grating typically is formed on or underneath an active area with a period equal to an integer multiple of half of an oscillation wavelength λ, that is nλ/2 where n=1, 2, 3 . . . . The grating enables a single longitudinal mode oscillation, i.e. a single axial mode oscillation.

FIG. 1 is a view illustrating a conventional DFB semiconductor laser including a grating 20 formed on an active layer 11. This DFB semiconductor laser is disclosed in U.S. Pat. No. 5,982,804, entitled “Non-regrowth distributed feedback ridge semiconductor laser and method of manufacturing the same”, Nov. 9, 1999. In this conventional DFB semiconductor laser, an n-InP clad layer 10 and a separate confinement hetrostructure (SCH) active layer 11 are stacked on an n⁺-InP substrate 9. A ridge 15 formed of a p-InP clad layer and a contact layer 13 are formed in the center of the SCH active layer 11. A grating 20 is formed on the SCH active layer 11 on both sides of the ridge 15.

However, in the DFB semiconductor laser shown in FIG. 1, an additional photolithography process must be performed to form the grating 20. Further, the grating 20 is fabricated after forming the n-InP clad layer 10, the SCH active layer 11, the ridge 15, and the contact layer 13. Thus, it is required that the process of forming a photoresist pattern and the etching process must be performed precisely to fabricate the grating 20.

FIG. 2 is a view illustrating another prior art example of a DFB semiconductor laser including a grating underneath an active layer. This DFB semiconductor laser is published in U.S. Patent Application Publication No. 2004/0151224, entitled “Distributed feedback semiconductor laser oscillating at longer wavelength mode and its manufacture method,” Aug. 5, 2004. In the DFB semiconductor laser shown in FIG. 2, an n-type clad layer 52, an n-type guide layer 53 having a grating and a high refraction index, a layer 54 having a low refraction index, an active layer 55, a p-type guide layer 56, and a p-type clad layer 63 are sequentially stacked on an n-type substrate 51. A p+ contact layer 64, an insulating layer 65, and a p-type electrode 20 are formed on the p-type clad layer 63. Reference numerals 61 and 62 shown in FIG. 2 respectively denote a p-type buried layer and an n-type buried layer.

In this conventional DFB semiconductor laser, an additional photolithography process must be performed to fabricate the grating. Further, a sample must be taken out of a growth apparatus to fabricate the grating, and this exposure can contaminate or oxidize the DFB semiconductor laser. Thus, a difficult process of removing the undesired oxide layer is subsequently required in fabricating this conventional DFB semiconductor laser. In addition, it is also required that the process of forming a photoresist pattern and the etching process must be performed precisely to form the grating on the n-type guide layer 53.

In these conventional DFB semiconductor lasers shown in FIGS. 1-2, the grating is formed on or underneath the active layer. As a result, one or more other wavelengths in addition to the desired wavelength are also lased according to a selection rule. To correct this problem, a highly complex technique of inserting a shifter producing a λ/4 shift must be performed during the fabrication of the grating.

Also, these conventional DFB semiconductor lasers shown in FIGS. 1-2 require a buried heterostructure confining a horizontal length of an active layer to confine the laser beam in the vertical direction (the X-axis) of the resonance axis (the Z-axis), i.e. a resonance width direction, so as to obtain a laser beam having a single wavelength.

### SUMMARY OF THE INVENTION

The present invention provides a DFB semiconductor laser lasing a single wavelength, in which the horizontal length of an active layer is controlled to control a transverse electromagnetic mode.

The present invention also provides a method of fabricating a DFB semiconductor laser without an additional photolithography process, to simplify a process and reduce the fabrication cost.

According to an aspect of the present invention, there is provided a distributed feedback semiconductor laser including: a lower clad layer formed on a substrate; a ridge including an active layer and an upper clad layer sequentially formed on the lower clad layer; and a grating formed at a sidewall of the ridge including the active layer in a direction perpendicular to the active layer and a resonance axis so as to enable a single longitudinal mode oscillation.

The active layer may be a separate confinement hetrostructure active layer. The separate confinement hetrostructure active layer may include a lower waveguide, an active layer including quantum dots, and an upper waveguide.

The grating may have a period equal to an integer multiple of half of an oscillation wavelength λ (nλ/2, n=1, 2, 3 . . . ). When the grating is formed at both sidewalls of the ridge, the grating may be symmetrical or asymmetrical.

According to another aspect of the present invention, there is provided a distributed feedback semiconductor laser including: a lower clad layer formed on a substrate; a ridge including an active layer and an upper clad layer sequentially formed on the lower clad layer; a grating formed at a sidewall of the ridge including the active layer in a direction perpendicular to the active layer and a resonance axis so as to enable a single longitudinal mode oscillation; and an oxide layer formed at a sidewall of the upper clad layer constituting the ridge so as to control a transverse electromagnetic mode.

The grating may have a period equal to an integer multiple of half of an oscillation wavelength λ (nλ/2, n=1, 2, 3 . . . ).

According to still another aspect of the present invention, there is provided a method of fabricating a distributed feedback semiconductor laser, including: forming a lower clad layer on a substrate; forming a ridge including an active layer and an upper clad layer sequentially stacked on the lower clad layer; and forming a grating at a sidewall of the ridge including the active layer in a direction perpendicular to the active layer and a resonance axis so as to enable a single longitudinal mode oscillation.

The grating may have a period equal to an integer multiple of half of an oscillation wavelength λ (nλ/2, n=1, 2, 3 . . . ). When the grating is formed at both sidewalls of the ridge, the grating may be symmetrical or asymmetrical.

According to yet another aspect of the present invention, there is provided a method of fabricating a distributed feedback semiconductor laser, including: forming a lower clad layer on a substrate; sequentially forming an active layer, an upper clad layer, an ohmic bonding layer, and a hard mask layer on the lower clad layer; forming a photoresist pattern on the hard mask layer to form a grating in a direction horizontal for the active layer; etching the hard mask layer, the ohmic bonding layer, the upper clad layer, and the active layer using the photoresist pattern as a mask to form a ridge including a grating enabling a single longitudinal mode oscillation in a direction perpendicular to a resonance axis and the active layer; oxidizing both sidewalls of the upper clad layer constituting the ridge to form an oxide layer controlling a transverse electromagnetic mode; forming a passivation spacer on both sidewalls of the ridge; removing the hard mask layer; and forming ohmic metal layers on the ohmic bonding layer and a rear surface of the substrate.

The grating may have a period equal to an integer multiple of half of an oscillation wavelength λ (nλ/2, n=1, 2, 3 . . . ). The grating may be formed at one sidewall or both sidewalls of the ridge including the active layer in a direction perpendicular to the active layer and the resonance axis.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating a DFB semiconductor laser including a grating formed on an active layer according to prior art;

FIG. 2 is a view illustrating a DFB semiconductor laser including a grating formed underneath an active layer according to prior art;

FIGS. 3-9 are views illustrating a DFB semiconductor laser and a method of fabricating the DFB semiconductor laser according to an embodiment of the present invention; and

FIGS. 10-15 are views illustrating a DFB semiconductor laser and a method of fabricating the DFB semiconductor laser according to another embodiment of the present invention.

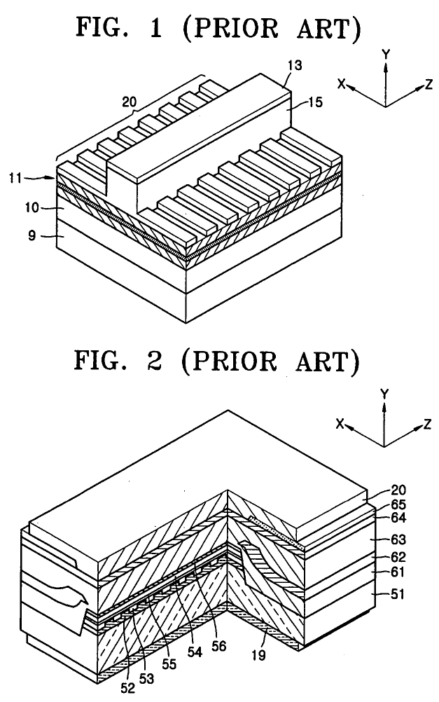

### DETAILED DESCRIPTION OF THE INVENTION

The present invention will now be described more fully with reference to the accompanying drawings, in which exemplary embodiments of the invention are shown. The invention may, however, be embodied in many different forms, and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. In the present specification, “( )” denotes materials that may or may not be included. For example, an In(Ga)As layer can denote either an InAs layer or an InGaAs layer.

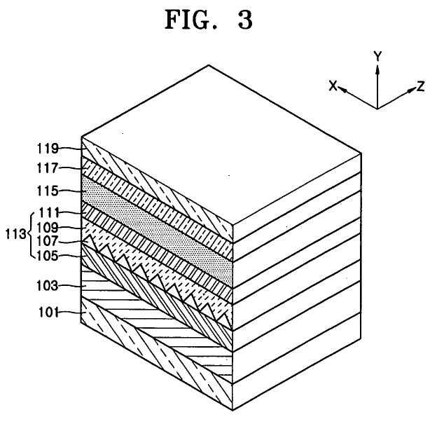

FIGS. 3-9 shows a DFB semiconductor laser according to an embodiment of the present invention Referring to FIG. 3, a lower clad layer 103 is formed on a substrate such as an InP substrate 101. Here, the lower clad layer 103 is formed of InAlAs layer. A separate confinement hetrostructure (SCH) active layer 113 is formed on the lower clad layer 103. The SCH active layer 113 includes a lower optical waveguide 105, an active layer 109 including quantum dots 107, and an upper optical waveguide 111. Here, the lower and upper optical waveguides 105 and 111 are formed of InAlAs layers. The quantum dots 107 are formed of In(Ga)As layer, and the active layer 109 is formed of InAl(Ga)As layer.

When the active layer 109 includes the quantum dots 107, a wide band communication wavelength ranging from 800 nm to 1600 nm can be produced, and a high speed signal of 20 Gbps or more can be transmitted in terms of optical modulation characteristics.

An upper clad layer 115 is formed on the upper optical waveguide 111 constituting the SCH active layer 113. Here, the upper clad layer 115 is formed of InAlAs layer. An ohmic bonding layer 117 is formed on the upper clad layer 115. Here, the ohmic bonding layer 117 is formed of InGaAs layer. A hard mask layer 119 is formed on the ohmic bonding layer 117. Here, the hard mask layer 119 is formed of SiONx layer (x being a positive integer).

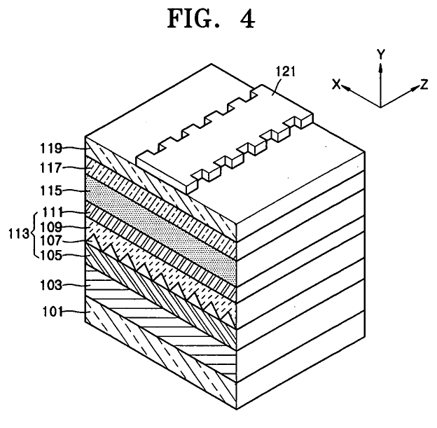

Referring to FIG. 4, a photoresist pattern 121 is formed on the hard mask layer 119 using a grating mask according to a photolithography process.

Uneven (prominence and depression) structures are formed at both sides of the photoresist pattern 121 along the resonance axis (which is the z-axis), i.e. a direction horizontal for the active layer 109. These uneven structures are used later to embody a grating.

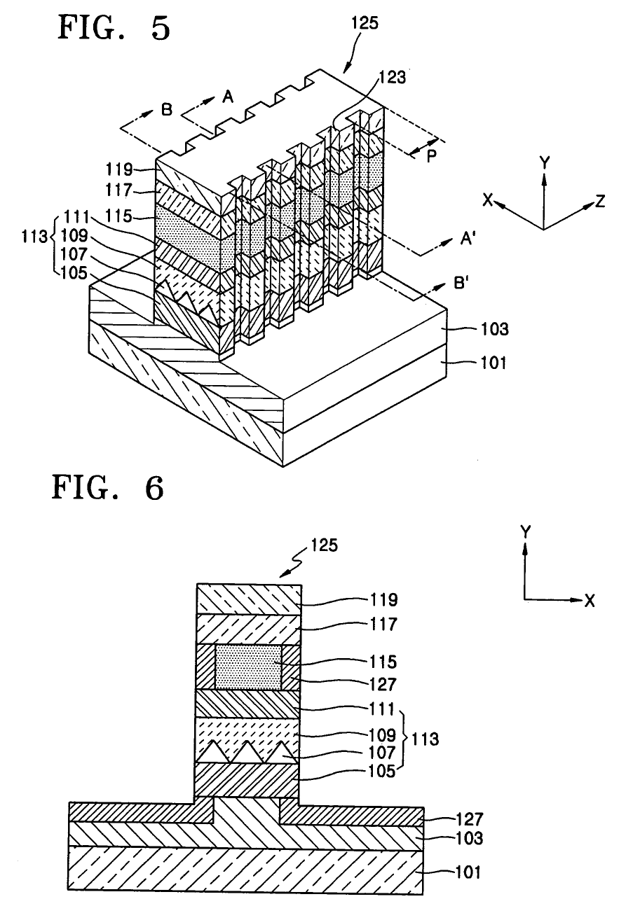

Referring to FIG. 5, the hard mask layer 119, the ohmic bonding layer 117, the upper clad layer 115, and the SCH active layer 113 are anisotropically dry etched using the photoresist pattern 121 as a mask to form a ridge 125 including a grating 123. The grating 123 is formed at both sidewalls of the ridge 125 including the active layer 109 in a direction perpendicular to the active layer 109 and the resonance axis (Z axis).

The grating 123 has a plurality of grooves equally spaced at a period P equal to an integer multiple of half of a resonance wavelength λ, that is nλ/2 where n=1, 2, 3 . . . , to obtain a distributed feedback effect so as to enable a single longitudinal mode oscillation. In other words, the laser oscillation of a single wavelength can be created by the grating 123. The grooves of the grating 123 formed on both parallel sidewalls of the ridge 125 may be symmetrical or asymmetrical in the X-axis direction. After the ridge 125 including the grating 123 is formed, the photoresist pattern 121 is removed.

FIGS. 6-9 are cross-sectional views taken along any line along the x-axis direction such as the line A-A′ or B-B′ shown in FIG. 5. It should be readily understood that the width of the ridge 125 taken along B-B′ is wider than the width of the ridge 125 taken along A-A′ although this difference is not specifically shown in FIG. 6. Referring to FIG. 6, the upper and lower clad layers 115 and 103 are selectively dry or wet oxidized to form an oxide layer 127. That is, the portions of the upper clad layer 115 at both sidewalls of the ridge 125 are etched, and the portions of the of the lower clad layer 103 at both sidewalls of the ridge 125 and the surface along the x-z plane are etched. The dry oxidizing is performed using O₂, but the wet oxidizing is performed using H₂O. The oxide layer 127 is an InAlOx layer.

The oxide layer 127 is formed at both sidewalls of the upper clad layer 115 and on the surface of the lower clad layer 130 exposed by the ridge 125. The degree of oxidization of the oxide layer 127 formed at the both sidewalls of the upper clad layer 115 constituting the ridge 125 may be controlled to determine the horizontal length of the active layer 109 in the X-axis direction. As a result, a transverse electromagnetic mode of an oscillated laser beam may be controlled.

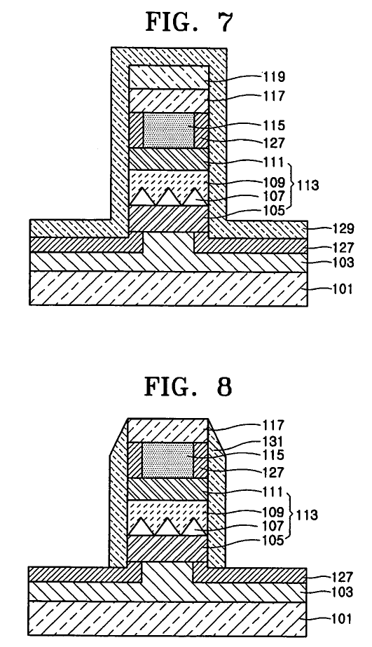

Referring to FIGS. 7-8, a passivation layer 129 is formed to cover the both sidewalls of the ridge 125 including the SCH active layer 113, the upper clad layer 125, the ohmic bonding layer 117, the hard mask layer 119 and the oxide layer 127, and the surface of the oxide layer 127 on the lower clad layer 103. Here, the passivation layer 129 is formed to passivate the SCH active layer 113.

As shown in FIG. 8, the passivation layer 129 is anisotropically etched to form a passivation spacer 131 on both sidewalls of the ridge 125. The surface of the ohmic bonding layer 117 is exposed when the passivation spacer 131 is formed. The hard mask layer 119 is removed.

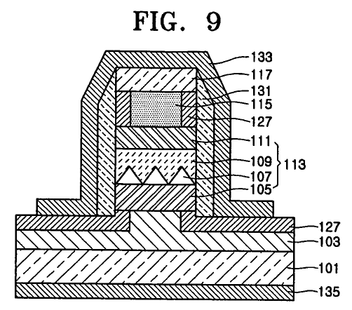

Referring to FIG. 9, ohmic electrodes 133 and 135 are respectively formed on the surface of the ohmic bonding layer 117 and the rear surface of the substrate 101 to complete the DFB semiconductor laser. A current is applied via the ohmic electrodes 133 and 135 so that the active layer 109 of the DFB semiconductor laser oscillates a laser beam.

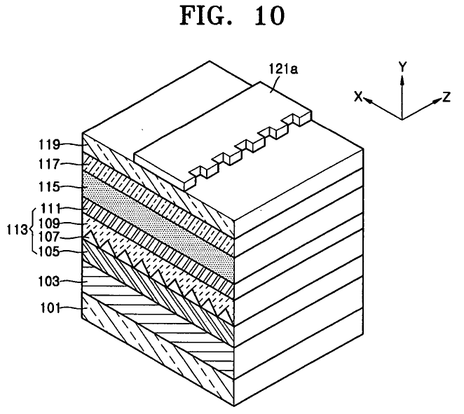

FIGS. 10-15 shows a DFB semiconductor laser according to another embodiment of the present invention.

The present embodiment is generally same as the previous embodiment except that a grating is formed only at one sidewall of a ridge. Reference numerals common to FIGS. 10-15 and FIGS. 2-9 denote equivalent elements.

Referring to FIG. 10, the process of the previous embodiment described with reference to FIG. 3 is performed. A photoresist pattern 121a is then formed on the hard mask layer 119 using a grating mask according to a photolithography process. That is, the photoresist pattern 121a is formed using the grating mask including a grating to be formed later according to the photolithography process. In contrast to the previous embodiment shown in FIG. 4, the uneven structures of this embodiment are formed only at one side of the photoresist pattern 121a as shown in FIG. 19 along the resonance axis (which is the Z-axis), i.e. a direction horizontal to for the active layer 109. The uneven structures are used later to embody the grating.

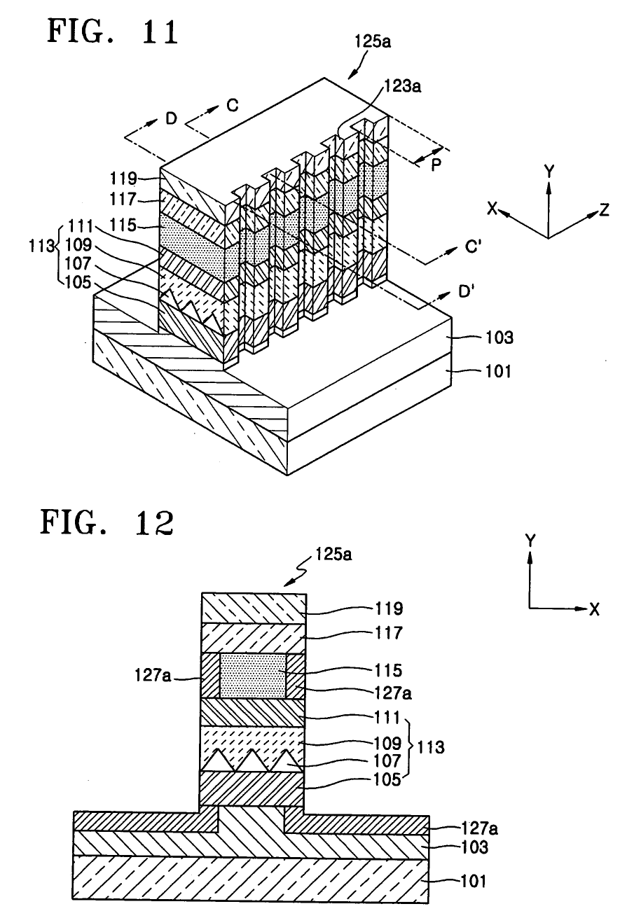

Referring to FIG. 11, the hard mask layer 119, the ohmic bonding layer 117, the upper clad layer 115, and the SCH layer 111 are anisotropically dry etched using the photoresist pattern 121a as a mask to form a ridge 125a including a grating 123a. The grating 123a is formed at one sidewall of the ridge 125a including the active layer 109 in the direction perpendicular to the active layer 109 and the resonance axis (i.e., the Z-axis).

The grating 123a is formed with a period P equal to an integer multiple of half of an oscillation wavelength λ, that is nλ/2 where n=1, 2, 3 . . . , to obtain a distributed feedback effect so as to enable a single longitudinal mode oscillation. In other words, a laser having a single wavelength may be oscillated by the grating 123a. After the ridge 125a including the grating 123a is formed, the photoresist pattern 121a is removed.

FIG. 12-15 are cross-sectional views taken along any line along the x-axis direction such the line C-C′ or D-D′ shown in FIG. 11. It should be readily understood that the width of the ridge 125 taken along D-D′ is wider than the width of the ridge 125 taken along C-C′ although this difference is not specifically shown in FIG. 12. Referring to FIG. 12, the upper and lower clad layers 115 and 103 are selectively dry or wet oxidized to form an oxide layer 127a. That is, the portions of the upper clad layer 115 at both sidewalls of the ridge 125 are etched, and the portions of the lower clad layer 103 at both sidewalls of the ridge 125 and the surface along the x-z plane are etched. The dry oxidizing is performed using O₂, but the wet oxidizing is performed using H₂O. The oxide layer 127a is an InAlOx layer.

The oxide layer 127a is formed at both sidewalls of the upper clad layer 115 constituting the ridge 125a, and on the surface of the lower clad layer 103 exposed by the ridge 125a, as in the previous embodiment. The degree of oxidization of the oxide layer 127a formed at a sidewall of the upper clad layer 115 constituting the ridge 125a may be controlled to determine the horizontal length of the active layer 109 in an X-axis direction. As a result, a transverse electromagnetic mode of oscillated laser beam may be controlled.

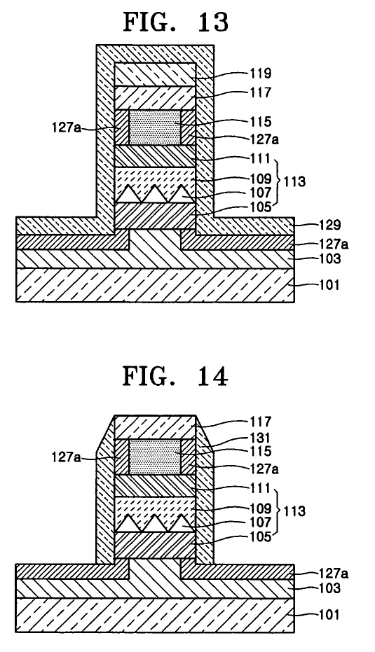

Referring to FIGS. 13-14, a passivation layer 129a is formed so as to cover a sidewall of the ridge 125a including the SCH active layer 113, the upper clad layer 115, the ohmic bonding layer 117, the hard mask layer 119 and the oxide layer 127a, and the surface of the oxide layer 127a on the lower clad layer 103. The passivation layer 129a is formed to passivate the SCH active layer 113.

As shown in FIG. 14, the passivation layer 129a is anisotropically etched to form a passivation spacer 131 on both sidewalls of the ridge 125a. The surface of the ohmic bonding layer 117 is exposed when the passivation layer 131 is formed. The hard mask layer 119 is removed.

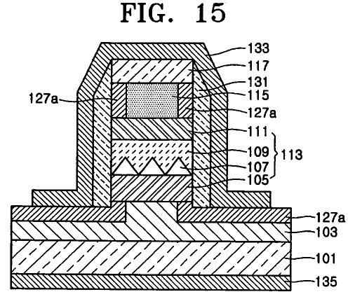

Referring to FIG. 15, ohmic electrodes 133 and 135 are respectively formed on the surface of the ohmic bonding layer 117 and the rear surface of the substrate 101 to complete the DFB semiconductor laser. A current is applied via the ohmic electrodes 133 and 135 so that the active layer 109 of the DFB semiconductor laser oscillates a laser beam.

As described above, according to the DFB semiconductor laser of the present invention and the method of fabricating the DFB semiconductor laser of the present invention, a grating is formed at one sidewall or both sidewalls of a ridge (such as 125) having an active layer (such as 113) such that the grating is formed in the direction perpendicular to the active layer (such as 113) and the resonance axis (such as the z-axis) so as to enable a single longitudinal mode oscillation.

Further, the upper clad layer (such as 115) can be selectively oxidized to control the horizontal length of the active layer (such as 113) so as to control a transverse electromagnetic mode.

In addition, it is not necessary to insert a grating on or underneath the active layer (such as 113). Thus, an additional photolithography process is not required, and a fabricating process can be simplified. As a result, the fabricating cost is reduced.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A distributed feedback semiconductor laser comprising:
a lower clad layer formed on a substrate; and
a ridge comprising an active layer and an upper clad layer sequentially formed on the lower clad layer,
wherein the active layer has a resonance axis and is capable of producing an oscillating optical signal; and
wherein a grating having equally spaced parallel grooves is formed on at least one sidewall of the ridge comprising the active layer such that the parallel grooves run in the direction perpendicular to the active layer and the resonance axis so as to enable a single longitudinal mode oscillation.

2. The distributed feedback semiconductor laser of claim 1, wherein the parallel grooves of the grating are equally spaced at a period equal to an integer multiple of half of an oscillation wavelength λ (nλ/2, n=1, 2, 3 . . . ).

3. The distributed feedback semiconductor laser of claim 1, wherein the active layer is a separate confinement hetrostructure active layer.

4. The distributed feedback semiconductor laser of claim 3, wherein the separate confinement hetrostructure active layer comprises a lower waveguide, a second active layer comprising quantum dots, and an upper waveguide.

5. The distributed feedback semiconductor laser of claim 4, wherein:
the substrate is made of material including InP;
the lower clad layer is made of material including InAlAs;
the lower waveguide is made of material including InAlAs;
the second active layer is made of material including InAlAs or AnAlGaAs;
the quantum dots are made of material including InAs or AnGaAs;
the upper waveguide made of material including InAlAs; AND
the upper clad layer is made of material including InAlAs.

6. The distributed feedback semiconductor laser of claim 1, further comprising an oxide layer formed on both sidewalls of at least the upper clad layer in the ridge.

7. The distributed feedback semiconductor laser of claim 1, wherein the grating is formed on each of two parallel sidewalls of the ridge.

8. The distributed feedback semiconductor laser of claim 7, wherein the gratings formed on the two parallel sidewalls of the ridge are symmetrical or asymmetrical.

9. The distributed feedback semiconductor laser of claim 1, wherein the ridge further comprises an ohmic bonding layer formed on the upper clad layer.

10. The distributed feedback semiconductor laser of claim 9, wherein the ohmic bonding layer is made of material including InGaAs.

11. A distributed feedback semiconductor laser comprising:
a lower clad layer formed on a substrate;
a ridge comprising an active layer and an upper clad layer sequentially formed on the lower clad layer,
wherein the active layer has a resonance axis and is capable of producing an oscillating optical signal; and
wherein a grating having equally spaced parallel grooves is formed on at least one sidewall of the ridge comprising the active layer such that the parallel grooves run in the direction perpendicular to the active layer and the resonance axis so as to enable a single longitudinal mode oscillation; and
an oxide layer formed on at least one sidewall of the upper clad layer in the ridge so as to control a transverse electromagnetic mode.

12. The distributed feedback semiconductor laser of claim 11, wherein the parallel grooves of the grating are equally spaced at a period equal to an integer multiple of half of an oscillation wavelength λ (nλ/2, n=1, 2, 3 . . . ).

13. The distributed feedback semiconductor laser of claim 11, wherein the grating is formed on each of two parallel sidewalls of the ridge.

14. The distributed feedback semiconductor laser of claim 11, wherein the ridge further comprises an ohmic bonding layer formed on the upper clad layer.

15. The distributed feedback semiconductor laser of claim 14,
wherein the substrate is made of material including InP; the lower clad layer is made of material including InAlAs; the upper clad layer is made of material including InAlAs; the ohmic bonding layer is made of material including InGaAs; and
wherein the active layer is a separate confinement hetrostructure active layer comprising:
a lower waveguide made of material including InAlAs;
a second active layer comprising quantum dots such that the second active layer is made of material including InAlAs or AnAlGaAs and the quantum dots are made of material including InAs or AnGaAs; and
an upper waveguide made of material including InAlAs.

16. A method of fabricating a distributed feedback semiconductor laser, comprising:
forming a lower clad layer on a substrate; and
forming a ridge comprising an active layer and an upper clad layer sequentially stacked on the lower clad layer, wherein the active layer has a resonance axis and is capable of producing an oscillating optical signal; and
forming a grating having equally spaced parallel grooves on at least one sidewall of the ridge comprising the active layer such that the parallel grooves run in the direction perpendicular to the active layer and the resonance axis so as to enable a single longitudinal mode oscillation.

17. The method of claim 16, wherein the parallel grooves of the grating are equally spaced at a period equal to an integer multiple of half of an oscillation wavelength λ (nλ/2, n=1, 2, 3 . . . ).

18. The method of claim 16, wherein the grating is formed on each of two parallel sidewalls of the ridge.

19. The method of claim 18, wherein the gratings formed on the two parallel sidewalls of the ridge are symmetrical or asymmetrical.

20. The method of claim 16,
wherein the substrate is made of material including InP; the lower clad layer is made of material including InAlAs; the upper clad layer is made of material including InAlAs; and
wherein the active layer is a separate confinement hetrostructure active layer comprising:
a lower waveguide made of material including InAlAs;
a second active layer comprising quantum dots such that the second active layer is made of material including InAlAs or AnAlGaAs and the quantum dots are made of material including InAs or AnGaAs; and
an upper waveguide made of material including InAlAs.

21. The method of claim 16, wherein the ridge further comprises an ohmic bonding layer formed on the upper clad layer.

22. The method of claim 21, wherein the ohmic bonding layer is made of material including InGaAs.

23. A method of fabricating a distributed feedback semiconductor laser, comprising:
forming a lower clad layer on a substrate;
sequentially forming an active layer, an upper clad layer, an ohmic bonding layer, and a hard mask layer on the lower clad layer, wherein the active layer has a resonance axis and is capable of producing an oscillating optical signal;
forming a photoresist pattern on the hard mask layer, the photoresist pattern shaped to an outline of a plurality of equally spaced parallel grooves in a grating;
etching the hard mask layer, the ohmic bonding layer, the upper clad layer, and the active layer using the photoresist pattern as a mask to form a ridge having sidewalls, wherein a grating having a plurality of equally spaced parallel grooves running in the direction perpendicular to the resonance axis and the active layer is formed on at least one sidewall of the ridge to enable a longitudinal mode oscillation;
oxidizing both sidewalls of the upper clad layer in the ridge to form an oxide layer controlling a transverse electromagnetic mode;
forming a passivation spacer on both sidewalls of the ridge;
removing the hard mask layer; and
forming ohmic metal layers on the ohmic bonding layer and a rear surface of the substrate.

24. The method of claim 23, wherein a second oxide layer is also formed on a surface of the lower clad layer when the upper clad layer in the ridge is oxidized.

25. The method of claim 23, wherein the parallel grooves of the grating are equally spaced at a period equal to an integer multiple of half of an oscillation wavelength λ (nλ/2, n=1, 2, 3 . . . ).

26. The method of claim 23, wherein the grating is formed on each of two parallel sidewalls of the ridge.

27. The method of claim 26, wherein the grating formed on the two parallel sidewalls of the ridge are symmetrical or asymmetrical.

28. The method of claim 23, wherein the active layer is formed of a separate confinement hetrostructure layer comprising quantum dots made of material including InAs or InGaAs.

29. The method of claim 28, wherein:
wherein the substrate is made of material including InP; the lower clad layer is made of material including InAlAs; the upper clad layer is made of material including InAlAs; the ohmic bonding layer is made of material including InGaAs; and
wherein the separate confinement hetrostructure active layer further comprises:
a lower waveguide made of material including InAlAs;
a second active layer comprising the quantum dots such that the second active layer is made of material including InAlAs or AnAlGaAs and the quantum dots are made of material including InAs or AnGaAs; and
an upper waveguide made of material including InAlAs.
